(19) United States
(12) Patent Application Publication
(10) Pub. No.: US 2020/0317923 A1
(43) Pub. Date: Oct. 8, 2020

(54) GENERATIVE METHOD FOR PRODUCING MOLDED BODIES USING A SUPPORT MATERIAL MADE OF WAX

(71) Applicant: Wacker Chemie AG, München (DE)

(72) Inventor: Torsten GOTTSCHALK-GAUDIG, Mehring (DE)

(73) Assignee: Wacker Chemie AG, Munich (DE)

(21) Appl. No.: 16/304,221

(22) PCT Filed: Feb. 23, 2017
(86) PCT No.: PCT/EP2017/054258

§ 371 Date: Nov. 23, 2018

(51) Int. Cl. C08L 91/06; B33Y 70/00; B29C 64/40

(52) U.S. Cl. CPC C08L 91/06; B33Y 10/00; B29C 64/40; B33Y 70/00

(57) ABSTRACT

An additive method of production of three-dimensional shaped bodies constructs the shaped body step by step by deploying a structure-forming material in liquid form in a location-specific manner, and additionally deploying a second material composed of wax as support material in regions that are to remain free of the structure-forming material and removing the support material after consolidation of the structure-forming material. The support material shows good dimensional stability and can be processed within a broad temperature window.

### CROSS REFERENCE TO RELATED APPLICATIONS

This application is the U.S. National Phase of PCT Appln. No. PCT/EP2017/054258 filed Feb. 23, 2017, the disclosure of which is incorporated in its entirety by reference herein.

### BACKGROUND OF THE INVENTION

### 1. Field of the Invention

The invention relates to an additive method of production of three-dimensional shaped bodies, which is characterized in that the shaped body is constructed step by step, by deploying the structure-forming material in liquid form in a location-specific manner, wherein a second material composed of wax is additionally deployed as support material in regions that are to remain free of the structure-forming material and is removed after the consolidation of the structure-forming material.

### 2. Description of the Related Art

Additive manufacturing methods are available for numerous materials and combinations thereof (e.g. metals, plastics, ceramics, glasses).

Different processing methods are available for the production of shaped bodies by the location-specific deployment of a liquid structure-forming material (SFM).

In the case of highly viscous or pasty SFMs, these may be deployed in the form of a bead by means of a nozzle and deposited in a location-specific manner. Deployment through the nozzle can be effected, for example, by pressure or by means of an extruder. A typical example of this processing method is 3D filament printing. A further known method is based on the ballistic metering of small amounts of SFM in the form of droplets that are deployed in a location-specific manner by means of printheads. In the case of low-viscosity inks having zero or near-zero shear thinning, the process is called inkjet printing; in the case of higher-viscosity, shear-thinning materials, the term “jetting” is in common use.

A prerequisite for all additive manufacturing methods is the presentation of the geometry and of any further properties (color, material composition) of the desired shaped body in the form of a digital 3D dataset which can be understood as a virtual model of the shaped body (A. Gebhardt, Generative Fertigungsverfahren [Additive Manufacturing Methods], Carl Hanser Verlag, Munich 2013). This modeling is preferably effected by means of various 3D-CAD (computer-aided design) construction methods. Input data used for the creation of a 3D-CAD model may also be 3D measurement data as result, for example, from CT (computer tomography) measurements or MRT (magnetic resonance tomography) measurements. The 3D-CAD dataset subsequently has to be supplemented with material-, process- and plant-specific data, which is accomplished by transmitting them via an interface in a suitable format (for example STL, CLI/SLC, PLY, VRML, AMF format) to an additive manufacturing software package. This software ultimately uses the geometric information to generate virtual individual layers (slices), taking account of the optimal orientation of the component in the construction space, support structures etc.

The full dataset then allows the direct actuation of the machine used for the additive manufacture (3D printer).

The software procedure is as follows:

1. Construction of the component in CAD format
2. Export to the STL data format
3. Division of the 3D model into slices parallel to the printing plane and generation of the GCode
4. Transmission of the GCode to the print controller

A common factor in all additive manufacturing methods with location-specific deployment of the SFM is the need for support structures in regions of cavities, undercuts or overhangs, since the location-specific deployment of the SFM always requires a supporting surface until the SFM has cured. Corresponding support materials (SM) for creation of auxiliary structures are known, for example, from WO 2017/020971 A1.

EP 0 833 237 A2 discloses the use of thermoplastic materials for 3D filament printing. Various materials are enumerated as structure-forming printing materials, for example waxes, thermoplastic resins or metals. The disadvantages of waxes when used in 3D printing, and especially by means of jetting, are a narrow temperature window for processing and low dimensional stability of the molten wax.

WO 2012/116047 A1 discloses the use of a wax component based on ethoxylated fatty alcohol as support material.

US 2005/0053798 A1 discloses a support material having only a small change in density in the course of cooling. Fatty acid esters are enumerated among the various suitable materials.

U.S. Pat. No. 5,136,515 discloses the use of waxes in 3D printing. The wax may be used as structure-forming material and also as support material, provided that these have a different melting point.

Overall, it can be stated that no process disclosed in the prior art is suitable for producing simple auxiliary structures for additive manufacturing methods with location-specific deployment of the SFM that have good printability in 3D printing, meaning that they can be printed within a broad temperature window and nevertheless have good dimensional stability in the melt. Furthermore, they should subsequently be removable again in a simple manner.

It was therefore an object of the present invention to provide an additive method for production of three-dimensional shaped bodies which permits not only the location-specific deployment of the structure-forming material (SFM) but also both construction and removal again of location-specific auxiliary structures of support material (SM) in a simple and inexpensive manner. In this case, the SM should rapidly develop its supporting properties, retain the supporting properties during the process, and then be removable again in a simple manner without damaging the shaped body or adversely affecting its properties. Furthermore, the SM should have good printability and be printable within a sufficient temperature window.

These objects are achieved by the method of the invention.

### SUMMARY OF THE INVENTION

The invention is directed to a method for additive manufacture of shaped bodies (8) by location-specific deployment of a structure-forming material (SFM)(=6b), characterized in that at the same time or a different time at least one support material (SM)=(6a) is deployed in regions that remain free of SFM (6b),
wherein the SM (6a) is deployed by means of an apparatus having at least one deployment unit (1a) for the SM (6a) which gradually constructs the support structure for the shaped body (8) by location-specific deployment of the SM (6a),
   with the proviso that the SM (6a)
      is a composition which, at a temperature above the solidification temperature Ts of the SM (6a), has structurally viscous, viscoelastic properties, comprising
         (A) at least one wax comprising at least one compound of the formula (I):

R′—COO—R″ (I)
where R′ and R″ may be the same or different and are selected from saturated or unsaturated, optionally substituted aliphatic hydrocarbyl groups having 10 to 36 carbon atoms,
(B) at least one particulate rheological additive, and
(C) optionally further additives,
has a shear viscosity of not more than 15 Pa·s (measured at a temperature of 10° C. above the solidification temperature Ts of the SM (6a) and a shear rate of 10 s⁻¹),
has a storage modulus G′ of at least 1 Pa (measured at a temperature of 10° C. above the solidification temperature Ts of the SM (6a)) and
has a solidification temperature Ts of 40° C. or more to 80° C. or less,
   and, on conclusion of the construction of the shaped body (8), the SM (6a) is removed from the shaped body (8).

### BRIEF DESCRIPTION OF THE DRAWINGS

FIG. 1 shows one embodiment of the method of the invention in schematic form.

FIG. 2 is a photograph of a spiral produced in jetting example J1.

FIG. 3 is a photograph of a spiral produced in jetting example J6.

### DETAILED DESCRIPTION OF THE PREFERRED EMBODIMENTS

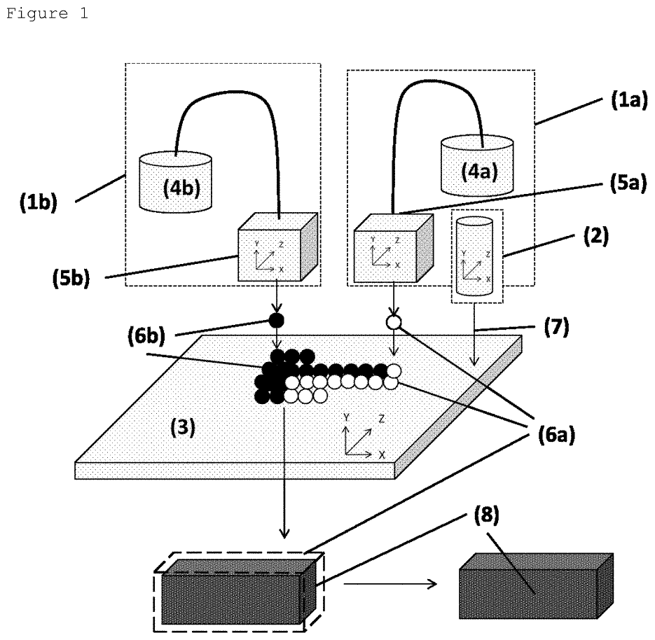

FIG. 1 shows, in schematic form, an example of how an additive manufacturing system of the invention can be constructed, with which the method of the invention for production of silicone elastomer parts (8) with auxiliary structures (6a) is conducted. The structurally viscous, viscoelastic SM (6a) is within the reservoir (4a) of an individual metering system (1a), which is pressurized and connected via a metering conduit to a metering nozzle (5a). The reservoir (4a) may have upstream or downstream devices that enable removal of dissolved gases by evacuation. The SFM (6b) is deployed by means of a further independent individual metering system (1b). The individual metering system (1b) is likewise equipped with a reservoir (4b) connected via a metering conduit to a metering nozzle (5b). The reservoir (4b) may also have upstream or downstream devices that enable removal of dissolved gases by evacuation.

The individual metering nozzles (5a) and (5b) may be accurately positioned together or preferably independently in x, y and z direction in order to enable targeted deposition of the SM (6a) or of the SFM (6b) on the base plate (3), which is preferably heatable and preferably likewise positionable in x, y and z directions, or, later on in the formation of the molding, on already positioned SM (6a) and/or already positioned, optionally already crosslinked SFM (6b).

Preferably, the device can be configured such that, instead of or in addition to the metering nozzles positionable in x, y, z directions, the molding or the base plate (3) can be positioned in x, y and z direction. The metering nozzles, the molding and the base plate (3) are preferably positioned with an accuracy of at least ±100 μm, more preferably of at least ±25 μm.

In addition, one or more radiation sources (2) for crosslinking of the SFM (6b) may be present, which can preferably likewise be positioned accurately in x, y and z directions, and can partly or fully crosslink the SFM (6b) by means of radiation (7).

Preference is given to positioning of the metering nozzles (5a) and (5b) and of the base plate using movement units with high repetition accuracy. The movement unit used for positioning of the metering nozzles (5a) and (5b) and of the base plate has an accuracy of at least ±100 μm, preferably of at least ±25 μm, in all three spatial directions in each case. The maximum speed of the movement units used is crucial in determining the production time of the molding (8) and should therefore be at least 0.1 m/s, preferably at least 0.3 m/s, more preferably at least 0.4 m/s.

Preference is given to metering nozzles (5a) and (5b) which enable jetting of liquid media of moderate to high viscosity. Particular examples of these include (thermal) bubble-jet and piezo printheads, particular preference being given to piezo printheads. The latter enable the jetting both of low-viscosity materials, in which case it is possible to achieve droplet volumes of a few picoliters (2 pL correspond to a dot diameter of about 0.035 μm), and of moderate- and high-viscosity materials such as the SM (6a), preference being given to piezo printheads having a nozzle diameter between 50 and 500 μm, and in which case it is possible to generate droplet volumes within the nanoliter range (1 to 100 nL). With low-viscosity materials (<100 mPa·s), these printheads can deposit droplets with very high metering frequency (about 1-30 kHz), whereas higher-viscosity materials (>100 mPa·s), depending on the rheological properties (shear-thinning characteristics), can achieve metering frequencies up to about 500 Hz.

The sequence in time of the construction of auxiliary structures (6a) or target structures (6b) is highly dependent on the desired geometry of the molding (8). Thus, it may be productive or even absolutely necessary first to construct at least parts of the auxiliary structures (6a) and then to generate the actual target structure (6b). Alternatively, it may be possible to generate both structures in parallel, i.e. without a time delay, i.e. by means of parallel metering from two independent metering units. Under some circumstances, it is more advisable first to construct at least parts of the target structure (6b) and then subsequently to at least partly construct support structures (6a). It may be the case that it is necessary to use all possible variants in the case of a component having complex geometry.

In the case of deployment of liquid, uncrosslinked SFMs (6b), for example acrylic resins or silicone rubber materials, these have to be crosslinked for formation of stable target structures (8). Preferably, the crosslinking of the droplet, for droplet-deposited SFMs (6b), is effected by means of one or more electromagnetic radiation sources (2) (e.g. IR laser, IR source, UV/VIS laser, UV lamp, LED), which preferably likewise have means of movement in x, y and z direction. The radiation sources (2) may have deflection mirrors, focusing units, beam widening systems, scanners, shutters, etc. Deposition and crosslinking have to be matched to one another. The method of the invention encompasses all options that are conceivable in this regard. For example, it may be necessary first to cover a two-dimensional region of the x,y working plane with droplets of the SFM (6b) and then to wait for leveling (coalescence), in order only then to irradiate and crosslink this two-dimensional area. It may likewise be advisable to consolidate the area applied, for the purpose of contouring, at first only in the edge region and then to partly crosslink the inner region by means of suitable hatching. It may also be necessary to crosslink or partly crosslink individual droplets immediately after positioning thereof in order to prevent running. It may be appropriate to permanently irradiate the entire working area during molding formation in order to achieve complete crosslinking, or to subject it only briefly to the radiation in order to bring about incomplete crosslinking (green strength) in a controlled manner, which under some circumstances may be accompanied by better adhesion of the individual layers to one another. Consequently, it will generally be necessary for the parameters that determine the deposition and crosslinking to be matched to one another depending on the crosslinking system, the rheological characteristics and the adhesion properties of the SFM (6b) and of any other materials used.

Preferably, the SFMs (6b) used are liquid acrylates, acrylate-silicone copolymers or physical mixtures thereof, acrylate-functional silicones or pure silicone rubber materials.

Preference is given to the use of acrylate-silicone copolymers or physical mixtures thereof, acrylate-functional silicones or pure silicone rubber materials, particular preference to that of acrylate-functional silicones or pure silicone rubber materials, and, in a specific execution, to that of silicone rubber materials, especially of radiation-crosslinking silicone rubber materials.

In order to avoid or eliminate soiling of the metering nozzles, the plant shown in FIG. 1 can be supplemented with an automatic metering nozzle cleaning station.

The individual metering systems may have a temperature control unit in order to condition the rheological characteristics of materials and/or to exploit the lowering of viscosity resulting from elevated temperatures for the jetting.

Preferably, at least for the SMs (6a) used in accordance with the invention, the individual metering system (1b), the reservoir (4b) and optionally the metering conduit should be provided with temperature control units.

It may be the case that the individual metering system (1a) can deploy the SM (6a) in the form of a thin bead as well, i.e. by the dispensing method. This method has advantages particularly in the case of larger, flatter structures, for example with regard to the printing speed.

The method of the invention, for production of support structures (6a), may be combined with all known methods of additive manufacturing of structures where the structure-forming material (SFM)=(6b) is deployed in a location-specific manner in liquid form. These include filament printing, dispensing, inkjet printing and jetting.

Preference is given to the dispensing and jetting of moderate- to high-viscosity, shear-thinning liquid SFMs (6b), particular preference to the dispensing and jetting of addition-crosslinking silicone elastomers and, in a specific execution, to the jetting of UV-activated or radiation-crosslinking silicone elastomers.

The entire system outlined by way of example in FIG. 1 may also be accommodated in a vacuum chamber or inert gas chamber, for example in order to avoid UV-C radiation losses resulting from oxygen or to avoid air pockets in the molding.

Preferably, the printing space of the system or the entire system may be accommodated in a chamber for exclusion of air humidity, in which case the chamber may either be purged with dry air from the outside or the air in the chamber may be dried by pumped circulation through a drying unit, for example a drying cartridge containing molecular sieve or a condensation unit.

Preferably, the printing space or the entire system is climate-controlled or is accommodated in a climate-controlled room or building. Preferably, the printing process is effected within an air temperature range from 0° C. to 35° C., more preferably from 15° C. to 25° C.

Preferably, the temperature of the component and/or the printing space can be controlled independently of the ambient temperature in order to be able to control the process of solidification of the SM (6a). This can be accomplished, for example, by separate climate control of the printing space and/or temperature control of the base plate and/or direct temperature control of the molding, for example by means of temperature-controlled air purging.

Preferably, the temperature of the component is adjusted to a temperature below the solidification temperature Ts of the SM (6a), more preferably within a temperature range from 0° C. up to a temperature of 10° C. below the solidification temperature Ts of the SM (6a).

Preferably, the temperature of the component can be determined directly, for example by means of customary temperature sensors or by contactless temperature measurement.

The SM (6a) used in the method of the invention, which is structurally viscous and viscoelastic at a temperature above the solidification temperature Ts of the SM (6a), preferably consists of the following components:

(A) wax,
(B) particulate rheology additive, and
(C) optionally further additives.

### Component (A)

Component A comprises:

at least one wax comprising a compound of the formula (I):

R′—COO—R″ (I)

where R′ and R″ may be the same or different and are selected from saturated or unsaturated, optionally substituted aliphatic hydrocarbyl groups having 10 to 36 carbon atoms.

Preferably, the wax has a melting range between 40° C. and 80° C., more preferably between 50° C. and 70° C., especially between 55° C. and 65° C.

Component (A) preferably comprises compounds of the formula (I) preferably in an amount of 10% by weight or more, more preferably 20% by weight or more and most preferably 30% by weight or more, based on the total weight of component (A).

Preferably, component (A) comprises one or more natural waxes, for example animal or vegetable waxes, for example carnauba wax or beeswax.

Typically, natural waxes consist of substance mixtures comprising esters of fatty acids or wax acids and long-chain aliphatic primary alcohols, called the fatty alcohols or wax alcohols. In addition, natural waxes may also comprise free long-chain aliphatic carboxylic acids, ketones, alcohols and hydrocarbons.

Preferably, component (A) comprises beeswax.

Beeswax typically consists of myricin, a mixture of esters of long-chain alcohols and acids which is dominated by myricyl palmitate C₁₅H₃₁—COO—C₃₀H₆₁; in addition, free cerotic acid C₂₅H₅₁—COOH, melissic acid and similar acids, saturated hydrocarbons, alcohols and other substances (for example bee species-specific aromas) may be present.

In a particularly preferred embodiment, component (A) consists exclusively of beeswax.

The waxes used are typically commercial products that are sold, for example, by Norevo GmbH (Germany).

The melting ranges of the waxes can be determined, for example, by means of dynamic differential thermoanalysis DSC according to DIN EN ISO 11357-3: Netzsch STA449 F5 Jupiter instrument, sample weight: 13.52 mg, temperature range 25° C. to 100° C., heating/cooling rate 0.5 K/min, purge gas N₂; two runs are measured (one run consists of the following heating and cooling cycle: from 25° C. (0.5 K/min) to 100° C. and from 100° C. (0.5 K/min) to 25° C.); the second run is used for the evaluation. Typically, several phase transitions occur in the case of natural waxes, for example beeswax. In these cases, the melting range reported is the exothermic transition with the highest peak temperature.

### Component (B)

Particulate rheology additives used are preferably solid, finely divided inorganic particles.

Preferably, the particulate rheology additives have an average particle size <1000 nm measured by means of photon correlation spectroscopy on suitably diluted aqueous solutions, especially having an average primary particle size of 5 to 100 nm, determined by means of visual image evaluation on TEM images.

These primary particles may not exist in isolation, but may be constituents of larger aggregates and agglomerates.

Preferably, the particulate rheology additives are inorganic solids, especially metal oxides, particular preference being given to silicas. Preferably, the metal oxide has a specific surface area of 0.1 to 1000 m²/g (measured by the BET method according to DIN 66131 and 66132), more preferably of 10 to 500 m²/g.

The metal oxide may include aggregates (definition according to DIN 53206) within the range of diameters from 100 to 1000 nm, where the metal oxide includes agglomerates that are formed from aggregates (definition according to DIN 53206) and, depending on the external shear stress (for example resulting from the measurement conditions), can have sizes of 1 to 1000 μm.

For reasons relating to ease of industrial handling, the metal oxide is preferably an oxide having a covalent bonding component in the metal-oxygen bond, preferably an oxide in the solid state of matter of the main and transition group elements, such as one of main group 3, such as boron oxide, aluminum oxide, gallium oxide or indium oxide, or of main group 4, such as silicon dioxide, germanium dioxide, or tin oxide or dioxide, lead oxide or dioxide, or an oxide of transition group 4, such as titanium dioxide, zirconium oxide or hafnium oxide. Other examples are stable nickel oxides, cobalt oxides, iron oxides, manganese oxides, chromium oxides or vanadium oxides.

Particular preference is given to aluminum(III) oxides, titanium(IV) oxides and silicon(IV) oxides, such as wet-chemically prepared, for example precipitated, silicas or silica gels, or aluminum oxides, titanium dioxides or silicon dioxides produced in processes at elevated temperature, for example fumed aluminum oxides, titanium dioxides or silicon dioxides or silica.

Other particulate rheology additives are silicates, aluminates or titanates, or aluminum sheet silicates, such as bentonites, such as montmorillonites, or smectites or hectorites.

Particular preference is given to fumed silica which is prepared in a flame reaction, preferably from silicon-halogen compounds or organosilicon compounds, for example from silicon tetrachloride or methyldichlorosilanes, or hydrotrichlorosilane or hydromethyldichlorosilane, or other methylchlorosilanes or alkylchlorosilanes, including in a mixture with hydrocarbons, or any desired volatilizable or sprayable mixtures of organosilicon compounds as specified and hydrocarbons, for example in a hydrogen-oxygen flame, or else a carbon monoxide-oxygen flame. The silica can be prepared either with or without addition of water, for example in the purification step; preference is given to no addition of water.

Preferably, the metal oxides and especially the silicas preferably have a fractal dimension of the surface area Dₛ of not more than 2.3, more preferably of not more than 2.1, most preferably of 1.95 to 2.05, where the fractal dimension of the surface area Dₛ is defined as: particle surface area A is proportional to the particle radius R to the power of Dₛ. The fractal dimension of the surface area can be determined by means of small angle x-ray diffraction (SAXS).

Preferably, the metal oxides and especially the silicas preferably have a fractal dimension of the mass Dₘ of not more than 2.8, more preferably not more than 2.7, more preferably of 1.8 to 2.6. The fractal dimension of the mass Dₘ is defined here as:

particle mass M is proportional to the particle radius R to the power of Dₘ.

The fractal dimension of the mass can be determined by means of small-angle x-ray diffraction (SAXS).

Preferably, the particulate rheology additives (B) are nonpolar, i.e. surface-modified, especially hydrophobized, preferably silylated, finely divided inorganic particles.

Preference is given in this connection to hydrophobic silicas, particular preference to hydrophobic fumed silicas. Hydrophobic silica in this connection means nonpolar silicas that have been surface-modified, preferably silylated, as described, for example, in published specifications EP 686676 B1, EP 1433749 A1 or DE 102013226494 A1. For the silicas used in accordance with the invention, this means that the silica surface has been hydrophobized, i.e. silylated.

Preferably, the hydrophobic silicas used in accordance with the invention have been modified, i.e. silylated, with organosilicon compounds, for example

(i) organosilanes or organosilazanes of the formula (II)

R¹_{d}SiY_{4-d} (II)

and/or partial hydrolyzates thereof,
where
R¹ may be the same or different and is a monovalent, optionally substituted, optionally mono- or polyunsaturated, optionally aromatic hydrocarbyl radical which has 1 to 24 carbon atoms and may be interrupted by oxygen atoms,
d is 1, 2 or 3 and
Y may be the same or different and is a halogen atom, monovalent Si—N-bonded nitrogen radicals to which a further silyl radical may be bonded, —OR² or —OC(O)OR², where R² is a hydrogen atom or a monovalent, optionally substituted, optionally mono- or polyunsaturated hydrocarbyl radical which may be interrupted by oxygen atoms,
or
(ii) linear, branched or cyclic organosiloxanes composed of units of the formula (III)

R^{a}ₑ(OR⁴)_{f}SiO_{(4-e-f)/2} (III)

where
R³ may be the same or different and has one of the meanings given above for R¹,
R⁴ may be the same or different and has a meaning given above for R³,
e is 0, 1, 2 or 3,
f is 0, 1, 2, 3, with the proviso that the sum total of e+f≤3, and the number of these units per molecule is at least 2, or
mixtures of (i) and (ii).

The organosilicon compounds that are used for silylation of the silicas may, for example, be mixtures of silanes or silazanes of the formula (II), preference being given to those formed from methylchlorosilanes on the one hand or alkoxysilanes and optionally disilazanes on the other hand.

Examples of R¹ in formula (II) are preferably the methyl, octyl, phenyl and vinyl radical, more preferably the methyl radical and the phenyl radical.

Examples of R² are preferably the methyl, ethyl, propyl and octyl radical, preferably the methyl and ethyl radical.

Preferred examples of organosilanes of the formula (II) are alkylchlorosilanes such as methyltrichlorosilane, dimethyldichlorosilane, trimethylchlorosilane, octylmethyldichlorosilane, octyltrichlorosilane, octadecylmethyldichlorosilane and octadecyltrichlorosilane, methylmethoxysilanes such as methyltrimethoxysilane, dimethyldimethoxysilane and trimethylmethoxysilane, methylethoxysilanes such as methyltriethoxysilane, dimethyldiethoxysilane and trimethylethoxysilane, methylacetoxysilanes such as methyltriacetoxysilane, dimethyldiacetoxysilane and trimethylacetoxysilane, phenylsilanes such as phenyltrichlorosilane, phenylmethyldichlorosilane, phenyldimethylchlorosilane, phenyltrimethoxysilane, phenylmethyldimethoxysilane, phenyldimethylmethoxysilane, phenyltriethoxysilane, phenylmethyldiethoxysilane and phenyldimethylethoxysilane, vinylsilanes such as vinyltrichlorosilane, vinylmethyldichlorosilane, vinyldimethylchlorosilane, vinyltrimethoxysilane, vinylmethyldimethoxysilane, vinyldimethylmethoxysilane, vinyltriethoxysilane, vinylmethyldiethoxysilane and vinyldimethylethoxysilane, disilazanes such as hexamethyldisilazane, divinyltetramethyldisilazane and bis(3,3-trifluoropropyl)-tetramethyldisilazane, cyclosilazanes such as octamethylcyclotetrasilazane, and silanols such as trimethylsilanol.

Particular preference is given to methyltrichlorosilane, dimethyldichlorosilane and trimethylchlorosilane or hexamethyldisilazane.

Preferred examples of organosiloxanes of the formula (III) are linear or branched dialkylsiloxanes having an average number of dialkylsiloxy units of greater than 3. The dialkylsiloxanes are preferably dimethylsiloxanes. Particular preference is given to linear polydimethylsiloxanes having the following end groups: trimethylsiloxy, dimethylhydroxysiloxy, dimethylchlorosiloxy, methyldichlorosiloxy, dimethylmethoxysiloxy, methyldimethoxysiloxy, dimethylethoxysiloxy, methyldiethoxysiloxy, dimethylacetoxysiloxy, methyldiacetoxysiloxy and dimethylhydroxysiloxy groups, especially having trimethylsiloxy or dimethylhydroxysiloxy end groups.

Preferably, the polydimethylsiloxanes mentioned have a viscosity at 25° C. of 2 to 100 mPa·s.

The hydrophobic silicas used in accordance with the invention preferably have a silanol group density of less than 1.8 silanol groups per nm², more preferably of not more than 1.0 silanol group per nm² and most preferably of not more than 0.9 silanol group per nm².

It has been found that, surprisingly, the use of hydrophobic silicas reduces or prevents shrinkage-related detachment of the printed shaped body from the carrier plate.

Hydrophobic silicas used in accordance with the invention preferably have a carbon content of not less than 0.4% by weight of carbon, more preferably 0.5% by weight to 15% by weight of carbon and most preferably 0.75% by weight to 10% by weight of carbon, where the weight is based on the hydrophobic silica.

The hydrophobic silicas used in accordance with the invention preferably have a methanol value of at least 30, more preferably of at least 40 and especially of at least 50.

The hydrophobic silicas used in accordance with the invention preferably have a DBP value (dibutyl phthalate value) of less than 250 g/100 g, more preferably 150 g/100 g to 250 g/100 g.

The hydrophobic silicas used in accordance with the invention preferably have a tamped density measured according to DIN EN ISO 787-11 of 20 g/L-500 g/L, more preferably of 30-200 g/L. The silanol group density is determined by means of acid-base titration, as disclosed, for example, in G. W. Sears, Anal. Chem. 1956, 28, 1981.

The carbon content can be determined by elemental analysis.

The methanol value is the percentage of methanol that has to be added to the water phase to achieve complete wetting of the silica. Complete wetting here means achieving complete immersion of the silica in the water/methanol test liquid.

The analytical methods for characterization of component (B) are additionally set out in more detail further down in the examples section.

Preferably, the particulate rheology additives (B) are polar, i.e. hydrophilic, i.e. unmodified, finely divided inorganic particles, preferably hydrophilic unmodified fumed silicas.

The unmodified, i.e. hydrophilic, polar silicas preferably have a specific surface area of 0.1 to 1000 m²/g (measured by the BET method according to DIN 66131 and 66132), more preferably of 10 to 500 m²/g.

The unmodified, i.e. hydrophilic, polar silicas preferably have a silanol group density of 1.8 silanol groups per nm² to 2.5 silanol groups per nm², more preferably 1.8 silanol groups per nm² to 2.0 silanol groups per nm².

The unmodified, i.e. hydrophilic, polar silicas have a methanol value of less than 30, preferably less than 20, more preferably less than 10 and, in a specific execution, the unmodified, i.e. hydrophilic, polar silicas are wetted completely by water without addition of methanol.

The unmodified, i.e. hydrophilic, polar silicas have a tamped density measured according to DIN EN ISO 787-11 of 20 g/L-500 g/L, preferably of 30-200 g/L and more preferably of 30-150 g/L.

The unmodified, i.e. hydrophilic, polar silicas used in accordance with the invention preferably have a DBP value (dibutyl phthalate value) of less than 300 g/100 g, preferably 150 g/100 g to 280 g/100 g.

Particulate rheology additives (B) used may be any desired mixtures of finely divided inorganic particles; in particular, it is possible to use mixtures of different silicas, for example mixtures of silicas of different BET surface area, or mixtures of silicas having different silylation or mixtures of unmodified and silylated silicas.

Preferably, in the case of mixtures of silylated, i.e. hydrophobic, nonpolar silicas and unmodified, i.e. hydrophilic, polar silicas, the proportion of the hydrophobic silicas in the total amount of silica is at least 50 percent by weight (% by weight), preferably at least 80% by weight and more preferably at least 90% by weight.

### Further Additives (C)

The inventive SM (6a) may, as well as components (A) and (B), comprise further functional additives, for example
colorants, such as organic or inorganic color pigments or dyes having molecular solubility;
industrially customary solvents, such as water, acetone, alcohols, aromatic or aliphatic hydrocarbons;
stabilizers, such as heat or UV stabilizers;
UV tracers, such as fluorescent dyes, for example rhodamines, fluoresceins or others for detection of residual SM traces on components;
polymers, such as polymeric rheology additives or leveling aids;
fillers, such as non-reinforcing fillers, for example fillers having a BET surface area of up to 50 m²/g, such as quartz, diatomaceous earth, calcium silicate, zirconium silicate, zeolites, aluminum oxide, titanium oxide, iron oxide, zinc oxide, barium sulfate, calcium carbonate, gypsum, silicon nitride, silicon carbide, sheet silicates, such as mica, montmorillonites, boron nitride, glass powder and carbon powder;
water scavengers or desiccants, for example molecular sieves or hydratable salts such as anhydrous Na₂SO₄, having an average particle size of less than 500 μm, preferably less than 100 μm, more preferably less than 50 μm, measured by means of laser diffraction.

### The Inventive SM (6a)

The inventive SM (6a) is preferably composed of 55% by weight or more to 99% by weight or less of (A), 1% by weight or more to 20% by weight or less of (B) and 0% by weight or more to 25% by weight or less of (C), based on the total weight of inventive SM (6a).

More preferably, the inventive SM (6a) is composed of 75% by weight or more to 98% by weight or less of (A), 2% by weight or more to 15% by weight or less of (B) and 0% by weight or more to 10% by weight or less of (C), based on the total weight of inventive SM (6a).

Most preferably, the inventive SM (6a) is composed of 80% by weight or more to 96% by weight or less of (A), 4% by weight or more to 10% by weight or less of (B) and 0% by weight or more to 10% by weight or less of (C), based on the total weight of inventive SM (6a).

The inventive SM (6a) is especially characterized in that it has structurally viscous and viscoelastic properties at a temperature above the solidification temperature Ts of the SM (6a).

Structurally viscous properties mean that the viscosity η(γ) of the SM (6a) is dependent on the shear rate γ and falls with increasing shear rate, this effect being reversible and the viscosity increasing again with decreasing shear rate.

Preferably, the SM (6a) used in accordance with the invention has a high viscosity at low shear rate at a temperature of 10° C. above the solidification temperature Ts of the SM (6a). Preferably, the viscosity measured at a shear rate of 1 s⁻¹ at a temperature of 10° C. above the solidification temperature Ts of the SM (6a) has a value of 0.1 Pa·s or greater, preferably a value between 0.1 Pa·s and 1000 Pa·s, more preferably between 0.2 Pa·s and 500 Pa·s and in a specific execution between 0.25 Pa·s and 100 Pa·s.

The SM (6a) used in accordance with the invention has a low viscosity at high shear rate at a temperature of 10° C. above the solidification temperature Ts of the SM (6a). The viscosity measured at a shear rate of 10 s⁻¹ at a temperature of 10° C. above the solidification temperature Ts of the SM (6a) has a value of not more than 15 Pa·s, preferably a value of 0.05 Pa·s or greater to 15 Pa·s or less, even more preferably of 0.075 Pa·s or greater to 10 Pa·s or less and in a specific execution of 0.1 Pa·s or greater to 9 Pa·s or less.

The method for determining the viscosity (=shear viscosity) is described in the examples.

The SM (6a) used in accordance with the invention is further characterized in that it has viscoelastic characteristics at a temperature of 10° C. above the solidification temperature Ts of the SM (6a) and especially preferably has viscoelastic solid-state properties in the linear viscoelastic (LVE) region. This means that, within the LVE region, defined according to T. G. Mezger, The Rheology Handbook, 2nd ed., Vincentz Network GmbH & Co. KG; Germany, 2006, 147 ff., the loss factor tan δ=G″/G′ has a value of less than 1, preferably less than 0.8 and more preferably less than 0.75.

The SM (6a) used in accordance with the invention is further characterized in that it preferably is a stable physical gel at a temperature of 10° C. above the solidification temperature Ts of the SM (6a). This means that the plateau value of the storage modulus G′ within the LVE region at a temperature of 10° C. above the solidification temperature Ts of the SM (6a) has a value of at least 1 Pa, preferably within the range from 5 to 5000 Pa and more preferably within the range from 5 to 2500 Pa.

The gel is further characterized in that the critical flow stress τ_{crit}, meaning the stress t at which G′=G″, preferably has a value of greater than 1 Pa, preferably greater than 2.5 Pa and more preferably greater than 3 Pa. The storage modulus G′, the loss factor tan δ and the critical shear stress τ_{crit} can be determined via rheological measurements with the aid of a rheometer as described below.

The SMs (6a) used in accordance with the invention have a phase transition within the temperature range from 40° C. to 80° C. In other words, the SMs (6a) used in accordance with the invention, when cooled within the temperature range from 40° C. to 80° C., have a transition from a liquid with viscoelastic characteristics to a solid. The solidification temperature Ts assigned to this phase transition can be obtained from a rheological temperature sweep experiment under dynamic stress on the sample with constant deformation and frequency while cooling within the temperature range from 85° C. to 20° C. For this purpose, the measurements of the magnitude of the complex viscosity |η*|(T) were analyzed with the aid of the Boltzmann sigmoidal function. The solidification temperature Ts of the SM (6a) is in the range from 40° C. or more to 80° C. or less, preferably in the range from 50° C. or more to 70° C. or less and more preferably in the range from 55° C. or more to 65° C. or less. Preferably, the solidification takes place within a narrow temperature range, i.e. the solidification curve |η*|(T) is steep. This means that the slope parameter dT of the Boltzmann sigmoidal function has a value of 0.1 to 1.5, preferably 0.1 to 1.0.

The solidification temperature of the SM (6a) is determined in particular by suitable choice of the wax component, especially by the appropriate melting range of the wax component. The further components of the composition have only a slight effect on the solidification temperature of the resulting SM.

The SM (6a) used in accordance with the invention is further characterized in that it is printable within a wide temperature range, i.e. gives a printed image without the formation of spattering or local variations in the geometric parameters. The temperature range is at least 1° C. or more, more preferably 2° C. or more.

The SM (6a) used in accordance with the invention is further characterized in that silicones can spread on the surface of the SM (6a). This means that the contact angle of a low molecular weight silicone oil (e.g. AK 100 from Wacker Chemie AG) has a value of less than 90°, preferably less than 60°, and there is more preferably spontaneous wetting of the SM without formation of a measurable contact angle.

The SM (6a) used in accordance with the invention is further characterized in that it does not change, i.e. does not have any degradation reactions, polymerizations or loss of stability, on brief irradiation with electromagnetic radiation, for example with UV light in the context of radiation crosslinking of the SFM (6b).

The SM (6a) used in accordance with the invention is preferably characterized in that, after curing of the SFM (6b), it can easily be removed from the shaped body (8) mechanically or by dissolution or emulsification in a solvent. This can be effected mechanically, for example by means of compressed air, spinning, for example by means of a centrifuge, brushes, scrapers or the like. In addition, the removal can be effected by dissolving or emulsifying in a suitable solvent.

Preference is given here to solvents that are environmentally friendly and present no risk to the end user, preferably water. Preferably, for this purpose, the solvent is heated and/or, in particular, suitable surfactants are added to the water, such as anionic, cationic or neutral surfactants. Optionally, the washing can be effected by machine, for example in a suitable washer.

Preferably, the SM (6a) used in accordance with the invention is recycled after removal from the shaped body (8). For this purpose, it has been found to be advantageous when the SM (6a) used in accordance with the invention has a low absorption capacity for volatile constituents of the SFM (6b), for example low molecular weight siloxanes in the case of silicone elastomers as SFM (6b).

In the production of the SM dispersions containing particulate rheology additives (B), the particulate rheology additives (B) are mixed into the wax component (A).

The particulate rheology additives (B), for production of the SM dispersions, can preferably be added to the liquid wax component (A) at temperatures above the melting range of component (A) and more preferably within a temperature range from 1° C. to 10° C. above the melting range of component (A) and distributed by wetting, or mixed by agitation, such as with a tumbling mixer, or a high-speed mixer, or by stirring. In the case of low particle concentrations below 10% by weight, simple stirring is generally sufficient for incorporation of the particles (B) into the liquid (A). Preferably, the particles (B) are incorporated and dispersed into the liquid wax component (A) at very high shear rate. Suitable equipment for this purpose is preferably high-speed stirrers, high-speed dissolvers, for example with speeds of rotation of 1-50 m/s, high-speed rotor-stator systems, sonolators, shear gaps, nozzles, ball mills inter alia.

Addition can be effected in batchwise and continuous processes, preference being given to continuous processes. Particularly suitable systems are those that first achieve the wetting and incorporation of the particulate rheology additives (B) into the wax component (A) with effective stirrer units, for example in a closed vessel or tank, and, in a second step, disperse the particulate rheology additives (B) at very high shear rate. This can be accomplished by means of a dispersing system in the first vessel, or by pumped circulation, in external pipelines containing a dispersing unit, out of the vessel and with recycling into the vessel in a preferably closed system. By partial recycling and partial continuous withdrawal, this process is preferably configured continuously.

An especially suitable method of dispersing the particulate rheology additives (B) in the SM dispersion is the use of ultrasound in the range from 5 Hz to 500 kHz, preferably 10 kHz to 100 kHz, most preferably 15 kHz to 50 kHz; ultrasound dispersion can be effected continuously or discontinuously. This can be accomplished by means of individual ultrasound emitters such as ultrasound tips, or in flow systems which, optionally by virtue of systems divided by a pipeline or pipe wall, contain one or more ultrasound emitters. Ultrasound dispersion can be effected continuously or batchwise.

Dispersion can be effected in customary mixing systems that are suitable for production of emulsions or dispersions and ensure a sufficiently high input of shear energy, for example high-speed stator-rotor stirrer systems, as known, for example, according to Prof. P. Willems under the registered trademark “Ultra-Turrax”, or other stator-rotor systems known under the registered trademark such as Kady, Unimix, Koruma, Cavitron, Sonotron, Netzsch or Ystral. Other methods are ultrasound methods such as US probes/emitters, or US flow cells, or US systems or analogous systems as supplied by Sonorex/Bandelin, or ball mills, for example Dyno-Mill from WAB, Switzerland. Further methods are high-speed stirrers, such as paddle stirrers or beam stirrers, dissolvers such as disk dissolvers, for example from Getzmann, or mixed systems such as planetary dissolvers, beam dissolvers or other combined aggregates composed of dissolver and stirrer systems. Other suitable systems are extruders or kneaders.

Preferably, the incorporation and dispersion of the particulate rheology additives (B) is effected under reduced pressure or includes an evacuation step.

Preferably, the incorporation and dispersion of the particulate rheology additives (B) is effected at elevated temperature above the melting range of component (A), more preferably within a temperature range from 10° C. above the melting range of component (A) up to a temperature of not more than 200° C. The temperature rise can preferably be controlled by external heating or cooling.

It will be appreciated that the SM dispersion can also be produced in other ways.

Preferably, the SMs (6a) used in accordance with the invention are dispensed into suitable metering containers (4a), such as cartridges, tubular bags or the like. Preferably, the metering containers (4a) are subsequently protected from ingress of air humidity by sealing them into metallized film, for example.

Preferably, the SMs (6a) used in accordance with the invention are degassed before and/or during the dispensing operation, for example by application of a suitable vacuum or by means of ultrasound.

Preferably, the SMs (6a) used in accordance with the invention are dried prior to the dispensing operation, for example by application of a suitable vacuum at elevated temperature. The content of free water in the SM (6a) used, i.e. water that has not been bound to water scavenger or desiccant, is less than 10% by weight, preferably less than 5% by weight, more preferably less than 1% by weight, based on the total mass of the SM. The content of free water can be determined quantitatively, for example, by means of Karl Fischer titration or NMR spectroscopy.

Preferably, the SMs (6a) used in accordance with the invention are dispensed at elevated temperature above the solidification temperature TS of the SM (6a), more preferably within a temperature range from 10° C. above the solidification temperature TS of the SM (6a) up to a temperature of not more than 200° C.

Preferably, the SMs (6a) used in accordance with the invention are deployed from the metering containers by mechanical pressure or by means of compressed air or reduced pressure.

Preferably, the SMs (6a) used in accordance with the invention are deployed from the metering containers at elevated temperature above the solidification temperature TS of the SM (6a), more preferably within a temperature range from 10° C. above the solidification temperature TS of the SM (6a) up to a temperature of not more than 100° C.

### EXAMPLES

The examples which follow serve to illustrate the present invention without restricting it.

All percentages are based on weight. Unless stated otherwise, all manipulations are executed at room temperature of 25° C. and at standard pressure (1.013 bar). The apparatuses are commercial laboratory equipment as supplied commercially by numerous equipment manufacturers.

### Analytical Methods for Characterization of the Silicas (Component B)

### Methanol Value

Test of wettability with water/methanol mixtures (% by volume of MeOH in water): shaking of a same volume of the silica with equal volumes of water/methanol mixture
starting with 0% methanol
if it is not wetted at least some of the silica floats: a mixture with a 5% by volume higher proportion of MeOH should be used
if it is wetted the entire volume of the silica sinks in: MeOH (% by volume) in water gives the methanol value.

### Carbon Content (% C)

The elemental analysis for carbon was effected according to DIN ISO 10694 using a CS-530 elemental analyzer from Eltra GmbH (D-41469 Neuss).

### Residual Silanol Content

The residual silanol content was determined analogously to G. W. Sears et al. Analytical Chemistry 1956, 28, 1981 ff. by means of acid-base titration of the silica suspended in a 1:1 mixture of water and methanol. The titration was effected in the range above the isoelectric point and below the pH range for dissolution of the silica. The residual silanol content in % can accordingly be calculated by the following formula:

SiOH=SiOH(silyl)/SiOH(phil) 100%

with
SiOH(phil): titration volume from the titration of the untreated silica
SiOH(silyl): titration volume from the titration of the silylated silica

### DBP Value

Dibutyl phthalate absorption is measured with a RHEOCORD 90 instrument from Haake, Karlsruhe. For this purpose, 12 g of the silicon dioxide powder, accurately to 0.001 g, are introduced into a kneading chamber which is closed with a lid, and dibutyl phthalate is metered in through a hole in the lid at a defined metering rate of 0.0667 mL/s. The kneader is operated at a motor speed of 125 revolutions per minute. On attainment of the maximum torque, the kneader and DBP metering are switched off automatically. The amount of DBP consumed and the amount of particles weighed in are used to calculate the DBP absorption according to: DBP value (g/100 g)=(consumption of DBP in g/weight of powder in g)×100.

### Rheological Measurements

All measurements were conducted in a rheometer (MCR 302 with air bearing from Anton Paar) at a temperature of 10° C. above the solidification temperature Ts of the SM, unless stated otherwise. Measurement was effected with plate-plate geometry (25 mm) at a gap width of 300 μm. After the plates had been closed to give the measurement gap, excess sample material was removed (“trimmed”) by means of a spatula. Before the start of the actual measurement profile, the sample was subjected to defined preliminary shear in order to eliminate the rheological history resulting from sample application and plate closure to attain the measurement position. The preliminary shear comprised a shear phase of 60 s at a shear rate of 100 s⁻¹ followed by a rest phase for 300 s.

The shear viscosities were ascertained from what is called a step profile in which the sample was subjected to shear at a constant shear rate of 1 s⁻¹ and 10 s⁻¹ for 120 s each. The measurement point duration was 12 s (1 s⁻¹) or 10 s (10 s⁻¹), and the shear viscosity reported was the average of the last 4 data points from a block.

The plateau value of the storage modulus G″, the loss factor tan δ and the critical shear stress τ_{crit} were obtained from a dynamic deformation test in which the sample, at a constant angular frequency of 10 rad/s, was subjected to increasing deformation amplitudes with defined deformation within the deformation range from 0.01 to 100. The measurement point duration was 30 s with 4 measurement points per decade. The plateau value of the storage modulus G′ is the average of data points 2 to 7 with the proviso that they are within the linear-viscoelastic range, i.e. have no dependence on deformation or shear stress. The value for the loss factor tan δ chosen was the value of the 4th measurement point.

The solidification temperature Ts of the SMs was determined by means of a temperature sweep under dynamic shear stress. This involved cooling the sample stepwise at a cooling rate of 1.5 K/min from 85° C. to 20° C. This was done by subjecting the sample to a constant deformation of 0.1% at a constant frequency of 10 Hz. The measurement point duration was 0.067 min. The storage modulus G′(T), the loss modulus G″(T), and the complex viscosity |η*|(T) are obtained, each as a function of temperature T. A plot of WI(T) against T gives a sigmoidal curve. The solidification temperature Tₛ is the temperature at which the curve has its turning point. This can be determined with the aid of the ORIGIN software by formation of the 1st derivative of the curve.

3D Printer:

For the examples of the method of the invention that are described hereinafter, the additive manufacturing system used was a “NEO-3D” printer from “German RepRap GmbH” which was modified and adapted for the experiments. The thermoplastic filament metering unit originally installed in the “NEO-3D” printer was replaced by a jetting nozzle from “Vermes Microdispensing GmbH, Otterfing”, in order to permit dropwise deposition of materials that have relatively high viscosity up to firm pasty consistency, such as the SMs used in accordance with the invention.

Because the “NEO” printer was not equipped as standard for the installation of jetting nozzles, it was modified. The Vermes jetting nozzle was incorporated into the printer control system such that the start-stop signal (trigger signal) for the Vermes jetting nozzle was actuated by the GCode controller of the printer. For this purpose, a special signal was recorded in the GCode controller. The GCode controller of the computer thus merely switched the jetting nozzle on and off (starting and stopping of the metering).

For the signal transmission of the start/stop signal, the heating cable for the originally installed filament heating nozzle of the “NEO” printer was severed and connected to the Vermes nozzle.

The other metering parameters (metering frequency, rising, falling etc.) of the Vermes jetting nozzle were adjusted by means of the MDC 3200+ Microdispensing Control Unit. The 3D printer was controlled by means of a computer. The software control and control signal interface of the 3D printer (software: “Repetier-Host”) were modified such that it was possible to control both the movement of the metering nozzle in the three spatial directions and the signal for droplet deposition. The maximum speed of movement of the “NEO” 3D printer is 0.3 m/s.

### Metering System:

The metering system used for the SM materials used or the radiation-crosslinking silicone elastomer structural material was the “MDV 3200 A” microdispensing metering system from “Vermes Microdispensing GmbH”, consisting of a complete system having the following components: a) MDV 3200 A—nozzle unit having a connection for Luer-Lock cartridges, pressurized with 3-8 bar compressed air at the top end of the cartridges (hose with adapter), b) Vermes MDH-230tf1 left-hand nozzle trace-heating system, c) MCH30-230 cartridge heater with MCH compressed air release valve for fixing of a hotmelt cartridge, MHC 3002 microdispensing heater controller and MCH-230tg heating cable, d) MDC 3200+ microdispensing control unit which was in turn connected to the PC controller and via movable cables to the nozzle enabled the setting of the jetting metering parameters (rising, falling, open time, needle lift, delay, no pulse, heater, nozzle, separation, voxel diameter, air supply pressure to the cartridge). Nozzles having diameters of 50, 100, 150 and 200 μm are available. It is thus possible to accurately position ultrafine SM droplets (6a) in the nanoliter range at any desired xyz position on the base plate or the crosslinked SFM (6b). Unless stated otherwise in the individual examples, the standard nozzle insert installed in the Vermes valve was a 200 μm nozzle (N₁₁-200 nozzle insert). The reservoir vessels (4a) used for the SM material (6b) were vertical 30 mL Luer-Lock cartridges that were screwed liquid-tight on to the dispensing nozzle and pressurized with compressed air.

The modified “NEO” 3D printer and the “Vermes” metering system were controlled with a PC and “Simplify 3D” open-source software.

### Radiation Source:

UV Chamber with Osram UV Lamp

Offline UV irradiation for crosslinking of the SFM (6b) of components was accomplished using a UV irradiation chamber which was reflective on the inside and had the following external dimensions:

| | | |
|---|---|---|
| Length | 50 | cm |
| Height | 19 | cm |
| Width | 33 | cm |

The distance between the fluorescent UV lamp and the substrate was 15 cm.

Radiation source: UV lamp with electrical power 36 watts, “Osram Puritec HNS L 36 W 2G11” type with a wavelength of 254 nm, Osram GmbH, Steinerne Furt 62, 86167 Augsburg.

Conditioning of the SM Materials or SFM Materials:

The SFM materials used were all devolatilized prior to processing in a 3D printer by storing 100 g of the material in an open PE nozzle in a desiccator at a reduced pressure of 10 mbar and room temperature (=25° C.) for 3 h. Subsequently, the material was dispensed with exclusion of air into a 30 mL cartridge with bayonet connection and connected to an appropriate expulsion plunger (plastic ram). The Luer-Lock cartridge was then screwed into the vertical cartridge holder of the Vermes metering valve in a liquid-tight manner with the Luer-Lock screw thread downward and the pressure ram was pressurized with compressed air to 3-8 bar at the upper end of the cartridge; the expulsion plunger present in the cartridge prevents the compressed air from being able to get into the material that has been evacuated to free it of bubbles beforehand.

The SM materials were melted at a temperature of 10° C. above the solidification temperature Ts of the SM in a nitrogen-flushed drying cabinet overnight, dispensed into cartridges and centrifuged while hot to free them of air at 2000 rpm for 5 min. The Luer-Lock cartridge was then screwed in a liquid-tight manner into the vertical cartridge heater of the Vermes metering valve with the Luer-Lock screw thread downward and the pressure ram was pressurized with compressed air to 3-8 bar at the upper end of the cartridge; the expulsion plunger present in the cartridge prevents the compressed air from being able to get into the material that has been centrifuged to free it of bubbles beforehand. Before commencement of the printing operation, the cartridges were heated to the target temperature for at least 30 min.

### Determination of the Printable Temperature Range:

(=nozzle heating temperature range (see table 3) The temperature range was determined from the printed image of rectangular spirals as mentioned below. Within the printable temperature range, a uniform rectangular spiral is obtained without occurrence of spattering or significant deviations in the geometric parameters of the spiral.

### Example 1 (B1)

A laboratory mixer from PC Laborsystem GmbH with a beam dissolver (dissolver disk diameter 60 mm) was initially charged with 380 g of a commercially available yellow beeswax having a melting range of 61-65° C. and an acid number of 17-22 mg KOH/g (available from Carl Roth GmbH+Co. KG) and, at a temperature of 65° C., 20 g of HDK® H18, a hydrophobic fumed silica (available from Wacker Chemie AG; for analytical data see table 1), were added in portions while stirring over a period of about 30 min. This was followed by dispersion at 70° C. at 800 rpm under reduced pressure for 1.0 h. A clear gel was obtained, which solidifies at temperatures below 60° C. to give a yellowish material, the analytical data of which are collated in table 2.

### Example 2 (B2)

A laboratory mixer from PC Laborsystem GmbH with a beam dissolver (dissolver disk diameter 60 mm) was initially charged with 370 g of a commercially available yellow beeswax having a melting range of 61-65° C. and an acid number of 17-22 mg KOH/g (available from Carl Roth GmbH+Co. KG) and, at a temperature of 65° C., 30 g of HDK® H18, a hydrophobic fumed silica (available from Wacker Chemie AG; for analytical data see table 1), were added in portions while stirring over a period of about 30 min. This was followed by dispersion at 70° C. at 800 rpm under reduced pressure for 1.0 h. A clear gel was obtained, which solidifies at temperatures below 60° C. to give a yellowish material, the analytical data of which are collated in table 2.

### Example 3 (B3)

A laboratory mixer from PC Laborsystem GmbH with a beam dissolver (dissolver disk diameter 60 mm) was initially charged with 360 g of a commercially available yellow beeswax having a melting range of 61-65° C. and an acid number of 17-22 mg KOH/g (available from Carl Roth GmbH+Co. KG) and, at a temperature of 65° C., 40 g of HDK® H18, a hydrophobic fumed silica (available from Wacker Chemie AG; for analytical data see table 1), were added in portions while stirring over a period of about 30 min. This was followed by dispersion at 70° C. at 800 rpm under reduced pressure for 1.0 h. A clear gel was obtained, which solidifies at temperatures below 60° C. to give a yellowish material, the analytical data of which are collated in table 2.

### Example 4 (B4)

A laboratory mixer from PC Laborsystem GmbH with a beam dissolver (dissolver disk diameter 60 mm) was initially charged with 360 g of a commercially available yellow beeswax having a melting range of 61-65° C. and an acid number of 17-22 mg KOH/g (available from Carl Roth GmbH+Co. KG) and, at a temperature of 65° C., 40 g of HDK® H20RH, a hydrophobic fumed silica (available from Wacker Chemie AG; for analytical data see table 1), were added in portions while stirring over a period of about 30 min. This was followed by dispersion at 70° C. at 800 rpm under reduced pressure for 1.0 h. A clear gel was obtained, which solidifies at temperatures below 60° C. to give a yellowish material, the analytical data of which are collated in table 2.

### Example 5 (B5)

A laboratory mixer from PC Laborsystem GmbH with a beam dissolver (dissolver disk diameter 60 mm) was initially charged with 370 g of a commercially available white beeswax having a melting range of 61-65° C. and an acid number of 17-22 mg KOH/g (available from Carl Roth GmbH+Co. KG) and, at a temperature of 65° C., 30 g of HDK® H18, a hydrophobic fumed silica (available from Wacker Chemie AG; for analytical data see table 1), were added in portions while stirring over a period of about 30 min. This was followed by dispersion at 70° C. at 800 rpm under reduced pressure for 1.0 h. A clear gel was obtained, which solidifies at temperatures below 60° C. to give a white mass, the analytical data of which are collated in table 2.

### Example 6 (B6)

A laboratory mixer from PC Laborsystem GmbH with a beam dissolver (dissolver disk diameter 60 mm) was initially charged with 360 g of a commercially available yellow beeswax having a melting range of 61-65° C. and an acid number of 17-22 mg KOH/g (available from Carl Roth GmbH+Co. KG) and, at a temperature of 65° C., 40 g of HDK® N20, a hydrophilic fumed silica (available from Wacker Chemie AG; for analytical data see table 1), were added in portions while stirring over a period of about 30 min. This was followed by dispersion at 70° C. at 800 rpm under reduced pressure for 1.0 h. A clear viscous liquid was obtained, which solidifies at temperatures below 60° C. to give a yellowish material, the analytical data of which are collated in table 2.

### Example 7 (B7; Noninventive)

A commercially available yellow beeswax having a melting range of 61-65° C. and an acid number of 17-22 mg KOH/g (available from Carl Roth GmbH+Co. KG) was subjected to rheological characterization analogously to examples B1-B6. The analytical data are collated in table 2.

TABLE 1

| | HDK ® | HDK ® | HDK ® | HDK ® |
|---|---|---|---|---|
| | H18 | H20RH | H20 | N20 |
| Methanol value (%) | 74 | 67 | 34 | 0 |
| % carbon | 4.8 | 10.1 | 1.6 | N/A |
| DBP value (g/100 g) | 165 | 224 | 197 | 250 |
| Residual SiOH (nm⁻¹) | 0.36 | 0.37 | 0.9 | 1.8 |

TABLE 2

| | Example 1 | Example 2 | Example 3 | Example 4 | Example 5 | Example 6 | Example 7 |
|---|---|---|---|---|---|---|---|
| | (B1) | (B2) | (B3) | (B4) | (B5) | (B6) | (B7) |
| Proportion of | 5 | 7.5 | 10 | 10 | 7.5 | 10 | N/A |
| pRA (%) | | | | | | | |
| η/1 s⁻¹ (Pa · s) | 4.3 | 13.3 | 81.2 | 1.1 | 12.6 | 0.72 | 0.017 |
| η/10 s⁻¹ (Pa · s) | 0.5 | 1.7 | 8.2 | 0.32 | 1.7 | 0.46 | 0.017 |
| Tₛ (° C.) | 60.8 | 60.3 | 60.2 | 60.4 | 60.8 | 60 | 61.4 |
| dT | 0.155 | 0.924 | 0.885 | 0.250 | 0.628 | 0.28 | 0.197 |
| G′ (Pa) | 51.5 | 953 | 2330 | 17.2 | 400 | 1.5 | N/A |
| tan δ | 0.2 | 0.19 | 0.161 | 0.638 | 0.215 | 2.27 | N/A |
| τ_{crit} (Pa) | 10.3 | 32.6 | 91.5 | 9.1 | 30.6 | N/A | N/A |

### Jetting Example J1

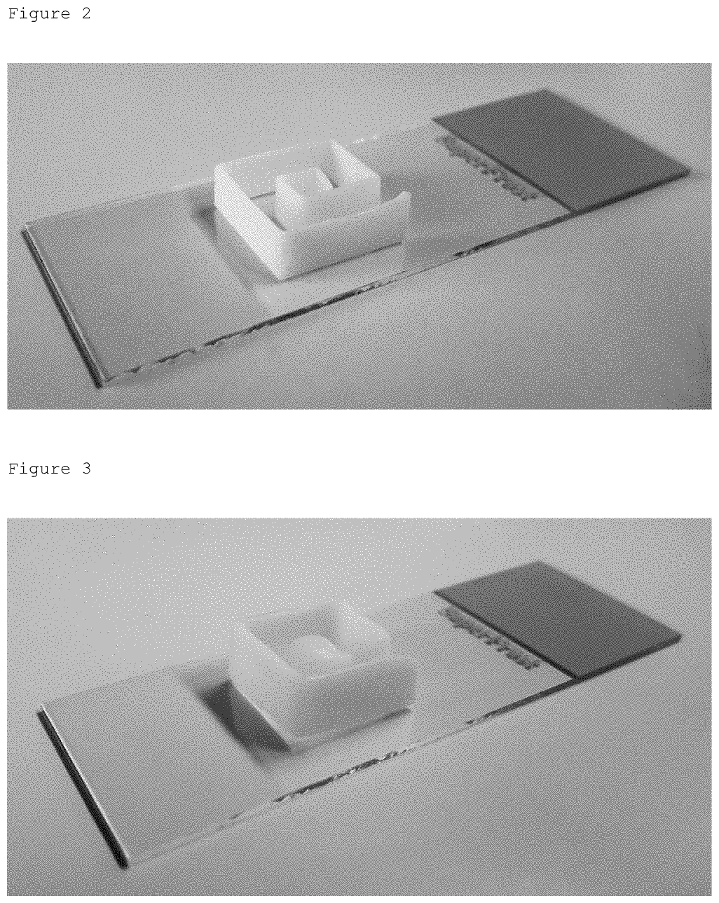

B1 was deposited dropwise with the jetting nozzle parameters as specified in table 3 on a glass microscope slide of area 25×75 mm to give a rectangular spiral having a wall thickness of about 900 μm and an edge length of 15 mm and a height of 10 mm. The rheological properties of the SM melt enable excellent dimensional stability and imaging accuracy of the geometry deposited. The result is a stable shaped body without shrinkage-related detachment from the glass plate (see FIG. 2).

### Jetting Example J2

B2 was deposited with the jetting nozzle parameters as specified in table 3. The result is a stable shaped body without shrinkage-related detachment from the glass plate analogous to J1.

### Jetting Example J3

B3 was deposited with the jetting nozzle parameters as specified in table 3. The result is a stable shaped body without shrinkage-related detachment from the glass plate analogous to J1.

### Jetting Example J4

B4 was deposited with the jetting nozzle parameters as specified in table 3. The result is a stable shaped body without shrinkage-related detachment from the glass plate analogous to J1.

### Jetting Example J5

B5 was deposited with the jetting nozzle parameters as specified in table 3. The result is a stable shaped body without shrinkage-related detachment from the glass plate analogous to J1.

### Jetting Example J6

B6 was deposited with the jetting nozzle parameters as specified in table 3. The result is a stable shaped body with shrinkage-related detachment from the glass plate (see FIG. 3).

### Jetting Example J7 (Noninventive)

B7 was deposited with the jetting nozzle parameters as specified in table 3. The desired shaped body was obtainable only under exactly controlled climatic ambient conditions (ambient climate control at exactly 25° C.). Only these conditions gave the result of a stable shaped body without shrinkage-related detachment from the glass plate analogous to J1.

### Jetting Example J11

SEMICOSIL® 810 UV 1K, a translucent silicone rubber material that undergoes addition crosslinking induced by UV light and has a viscosity of about 310 000 mPa·s (at 0.5 s⁻¹) and a Shore A vulcanizate hardness of 40 (available from WACKER CHEMIE AG) was deposited dropwise with the jetting nozzle parameters specified in table 4 on a glass microscope slide of area 25×75 mm to give a rectangular spiral having a wall thickness of 2 mm, an edge length of 15 mm and a height of 3.5 mm. The spiral was crosslinked in the above-described offline UV chamber with the crosslinking parameters specified above. Subsequently, after cleaning of the nozzle head and of the feed lines and after exchange of the cartridge, the cavity of the spiral was filled by jetting of support material B3 (for jetting nozzle parameters see table 4). Subsequently, after cleaning the nozzle head and the feed lines again and exchanging the S-M cartridge for a SEMICOSIL® 810 UV 1K cartridge, a lid having a thickness of 1.5 mm was printed onto the spiral and crosslinked as described above, and the support material was washed off with water.

TABLE 3

| | Example | Example | Example | Example | Example | Example | Example |
|---|---|---|---|---|---|---|---|
| | 1 (J1) | 2 (J2) | 3 (J3) | 4 (J4) | 5 (J5) | 6 (J6) | 7 (J7) |
| Nozzle | 200 | 200 | 200 | 200 | 200 | 200 | 200 |
| diameter | | | | | | | |
| (μm): | | | | | | | |
| Rising | 0.4 | 0.4 | 1 | 0.2 | 0.4 | 0.5 | 4 |
| (ms): | | | | | | | |
| Falling | 1 | 0.85 | 1 | 1.3 | 0.85 | 0.5 | 4 |
| (ms): | | | | | | | |
| Open time | 0 | 0 | 1 | 0 | 0 | 0.2 | 0 |
| (ms): | | | | | | | |
| Needle lift | 50 | 51 | 100 | 40 | 51 | 50 | 50 |
| (%): | | | | | | | |
| Delay (ms): | 100 | 100 | 100 | 100 | 100 | 100 | 100 |
| Cartridge | 70 | 67 | 85 | 78 | 67 | 70 | 65.2 |
| heating | | | | | | | |
| (° C.) | | | | | | | |
| Nozzle | 65-72 | 65-72 | 82-84 | 66-78 | 65-72 | 67-69 | 65.2-65.5 |
| heating | | | | | | | |
| temperature | | | | | | | |
| range (° C.): | | | | | | | |
| Cartridge | 1 | 2 | 2 | 2 | 2 | 2 | 2 |
| supply | | | | | | | |
| pressure | | | | | | | |
| (bar) | | | | | | | |
| Voxel | 920 | 740 | 1170 | 620 | 821 | 750 | 900 |
| diameter | | | | | | | |
| (μm) | | | | | | | |

The results in table 3 show clearly that the use of a particulate rheological additive leads to an increase in the printable temperature range (cf. nozzle heating temperature range of examples 1 to 6). More particularly, it was possible to more than double the temperature window compared to support materials lacking particulate rheological additive (cf. example 7).

TABLE 4

| | Example J11 | Example J11 |
|---|---|---|
| | Silicone | Support material |
| | material | B2 |
| Nozzle diameter (μm) | 200 | 200 |
| Rising (ms): | 0.3 | 0.4 |
| Falling (ms): | 0.1 | 0.85 |
| Open time (ms): | 15 | 0 |
| Needle lift (%): | 100 | 51 |
| Delay (ms) | 25 | 100 |
| Nozzle heating (° C.): | 40 | 70 |
| Cartridge heating (° C.) | — | 67 |
| Cartridge supply pressure (bar) | 3.0 | 3 |
| Voxel diameter (μm) | 700 | 700 |

1.-11. (canceled)

12. A method of additive manufacture of shaped bodies by location-specific deployment of a structure-forming material (SFM), comprising:
deploying, at the same time or a different time, at least one support material (SM) in regions that are desired to remain free of SFM,
wherein the SM is deployed by means of an apparatus having at least one deployment unit for the SM which gradually constructs the support structure for the shaped body by location-specific deployment of the SM,
with the proviso that the SM,
at a temperature above the solidification temperature Ts of the SM is a structurally viscous, viscoelastic composition comprising
(A) at least one wax comprising at least one compound of the formula (I):
R′—COO—R″ (I)
where R′ and R″ may be the same or different and are selected from saturated or unsaturated, optionally substituted aliphatic hydrocarbyl groups having 10 to 36 carbon atoms,
(B) at least one particulate rheological additive, and
(C) optionally further additives,
has a shear viscosity of not more than 15 Pa·s, measured at a temperature of 10° C. above the solidification temperature Ts of the SM, and a shear rate of 10 s⁻¹, measured with a rheometer having plate-plate geometry at a diameter of 25 mm and a gap width of 300 μm,
has a storage modulus G′ of at least 1 Pa, measured at a temperature of 10° C. above the solidification temperature Ts of the SM (6a), and
has a solidification temperature Ts of 40° C. or more to 80° C. or less, and, on conclusion of the construction of the shaped body, removing the SM from the shaped body.

13. The method of claim 12, wherein the deployment unit can be positioned in x, y and z directions with an accuracy of at least ±100 μm, and the location-specific deployment of the SM can be effected either in the x,y working plane or in z direction.

14. The method of claim 12, wherein R′ is a linear alkyl group having 10 to 15 carbon atoms and R″ is a linear alkyl group having 25 to 35 carbon atoms.

15. The method of claim 12, wherein component (A) comprises beeswax.

16. The method of claim 12, wherein component (B) comprises at least one silica.

17. The method of claim 12, wherein component (B) comprises at least one hydrophobic silica having a silanol group density of less than 1.8 silanol groups per nm², determined by means of acid-base titration.

18. The method of claim 12, wherein component (B) comprises at least one hydrophobic silica having a methanol value of at least 30.

19. The method of claim 12, wherein component (A) is present in an amount of 55% by weight or more to 99% by weight or less, based on the total weight of the SM.

20. The method of claim 12, wherein component (B) is present in an amount of 1% by weight or more to 20% by weight or less, based on the total weight of the SM.

21. The method of claim 12, wherein the SM is separated from the shaped body by dissolution or emulsification in a solvent or by mechanical means.

22. In an additive method of manufacture of shaped materials, the improvement comprising employing, as a support material a composition comprising:
(A) at least one wax comprising at least one compound of the formula (I):
R′—COO—R″ (I)
where R′ and R″ are the same or different and are saturated or unsaturated, optionally substituted aliphatic hydrocarbyl groups having 10 to 36 carbon atoms,
(B) at least one particulate rheological additive, and
(C) optionally further additives,
wherein the composition
at a temperature above the solidification temperature Ts of the SM is a structurally viscous, viscoelastic composition,
has a shear viscosity of not more than 15 Pa·s, measured at a temperature of 10° C. above the solidification temperature Ts of the SM, and a shear rate of 10 s⁻¹, measured with a rheometer having plate-plate geometry at a diameter of 25 mm and a gap width of 300 μm,
has a storage modulus G′ of at least 1 Pa, measured at a temperature of 10° C. above the solidification temperature Ts of the SM, and
has a solidification temperature Ts of 40° C. or more to 80° C. or less.
